(19) United States
(12) Patent Application Publication
(10) Pub. No.: US 2022/0332881 A1
(43) Pub. Date: Oct. 20, 2022

(54) METHOD FOR PRODUCING FLAMEPROOF PUR/PIR RIGID FOAMS

(71) Applicant: Covestro Intellectual Property GmbH & Co. KG, Leverkusen (DE)

(72) Inventors: Rolf Albach, Köln (DE); Stephan Schleiermacher, Pulheim (DE); Martina Wagner, Bergheim (DE)

(21) Appl. No.: 17/618,135

(22) PCT Filed: Jul. 6, 2020
(86) PCT No.: PCT/EP2020/069002

§ 371 Date: Dec. 10, 2021

(30) Foreign Application Priority Data
Jul. 12, 2019 (EP) 19185931.3

(51) Int. Cl. C08G 18/22; C08K 5/524; C08G 18/76; C08G 18/48; C08G 18/42; C08G 18/40; C08G 18/28; C08G 18/32; C08J 9/14; C08J 9/12

(52) U.S. Cl. CPC C08G 18/225; C08K 5/524; C08G 18/7664; C08G 18/4833; C08G 18/4202; C08G 18/4018; C08G 18/283; C08G 18/3206; C08G 18/425; C08G 18/4211; C08G 18/4208; C08J 9/141; C08J 9/125; C08G 2110/0025; C08G 2110/005; C08J 2203/10; C08J 2203/14; C08J 2375/06; C08J 2375/08; C08J 2471/08

(57) ABSTRACT

A polyol formulation for producing flameproof polyurethane/polyisocyanate rigid foams (referred to individually or jointly in the following as “PUR/PIR rigid foams”), containing a polyester polyol having an OH number ≤250 mg KOH/g, a functionality of 1.5 to 2.5 and a free glycol content with Mn<150 g/mol of <6 wt. %, a polyethylene glycol with an average molecular weight of <700 g/mol and an average functionality of <2.5 and specific polyethyleneglycol alkylphenyl ethers, and methods for producing PUR/PIR rigid foams using said polyol formulation and to the PUR/PIR rigid foams obtained thereby are provided.

### CROSS REFERENCE TO RELATED APPLICATIONS

This application is a U.S. national stage application, filed under 35 U.S.C. § 371, of International Application No. PCT/EP2020/069002, which was filed on Jul. 6, 2020, and which claims priority to European Patent Application No. 19185931.3 which was filed on Jul. 12, 2019. The contents of each are hereby incorporated by reference into this specification.

### FIELD

The present invention relates to a polyol formulation for producing rigid flame retardant polyurethane/polyisocyanurate foams (hereinbelow also referred to individually or in common as “rigid PUR/PIR foams”) containing a polyester polyol having an OH number≤250 mg KOH/g, a functionality of 1.5-2.5 and a content of free glycols of Mₐ<150 g/mol of <6% by weight, a polyethylene glycol having an average molar weight of <700 g/mol and an average functionality <2.5 and certain polyethylene glycol alkyl phenyl ethers and to processes for producing rigid PUR/PIR foams using this polyol formulation and to the thus-produced rigid PUR/PIR foams.

### BACKGROUND

In the present application the term “rigid PUR/PIR foams” refers to rigid foams comprising both urethane and isocyanurate structures.

Like all organic polymers rigid PUR/PIR foams are flammable, the large surface area per unit mass in foams further amplifying this behavior. Rigid PUR/PIR foams are often used as insulation materials, for example as insulation in the construction industry. Endowment with flame retardancy through added flame retardants is therefore necessary in many applications of rigid PUR/PIR foams.

The addition of larger amounts of flame retardants is known to have disadvantages, including for the mechanical properties of the polymers. Compounds containing halogens in particular are also subject to criticism because of their potential environmentally harmful or health-hazardous effects.

In polyurethane chemistry the fire properties of the polymer backbone may be controlled to a certain extent through the selection and composition of the monomers. The presence of isocyanurate structures for example has a positive effect on fire behavior. The use of high molecular weight polyester building blocks, as in US 2013/184366 A and US 2014/364528 A, is also said to lead to an increase in flame retardancy but, due to a premature increase in glass transition temperature, often also impedes the trimerization of isocyanate to isocyanurate structures which give the foam strength.

The processing of such high molecular weight and thus high viscosity polyol building blocks is costly and complex and technically problematic and their use is therefore limited.

One approach for reducing viscosity could be the admixture of polyether polyols. However, if industrially readily available polyethylene glycol (PEG) is to be used to establish the polyol formulation viscosity of around 3500-4000 mPa*s customary for many PUR/PIR applications the obtained foams often have an inadequate cell structure resulting in poor surfaces and properties inadequate for large industrial scale use.

US 2012/0202903 A describes the use of alkyl ethoxylate alcohols having an average HLB value between 10 and 15 as compatibilizers for polyol formulations which contain high proportions of water and are used for production of water blown polyurethane spray foams.

### SUMMARY

The present invention accordingly has for its object to provide a polyol formulation A containing a high molecular weight polyester polyol for production of rigid PUR/PIR foams, wherein the rigid PUR/PIR foams exhibit good flame retardancy and good mechanical properties.

This object has surprisingly been achieved by a polyurethane formulation A containing
A1 35-89% by weight, based on the total mass of the polyol formulation A, of a polyester polyol component having an OH number of 190-310 mg KOH/g, consisting of
   A1-1 at least one polyester polyol having an OH number≤250 mg KOH/g, an average functionality of 1.5-2.5 and a content of free glycols of Mₐ<150 g/mol of <6% by weight based on the total mass of A1-1,
   A1-2 optionally further polyester polyols not falling under the definition of A1-1,
A2 10-40% by weight, based on the polyol formulation A, of one or more polyethylene glycols having an average molar weight of <700 g/mol and an average functionality of <2.5;
A3 other isocyanate-reactive components
A4 0.2-5% by weight, based on the polyol formulation A, of one or more compounds selected from the group consisting of
   A4-1 a polyethylene glycol 2,4,6-trialkylphenyl ether (structure I where R5, R6, R7=H, C1- to C8-alkyl) and
   A4-2 polyethylene glycol 2,4,6-triaralkylphenyl ethers (structure I where R5, R6 and/or R7=aryl) and
   A4-3 polyethylene glycol alkyl phenyl ethers (structure II)

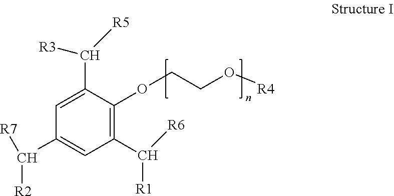

R1, R2, R3, R4=H, C1-C4-alkyl,
R5, R6, R7=H, C1- to C8-alkyl, aryl
n=7-20, preferably 10-18, particularly preferably 11-15

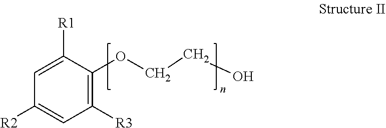

R1, R3=H, C(CH₃)₂CR4R5R6
R2=C(CH₃)₂CR4R5R6
R4, R5=H or CH₃
R6=C2- to C5-alkyl, aryl
n=3-8
wherein the compounds A4 have a molar weight of less than 1.5 kg/mol and a content of 25-70% ethylene oxide, preferably 40-60% ethylene oxide, and
A5 optionally further auxiliary and additive substances.
A6 0-2% by weight, based on the total mass of the polyol formulation A, of water.

The invention also relates to a process for producing rigid PUR/PIR foams by reacting a reaction mixture containing

the polyol formulation A,

a polyisocyanate component B and

a blowing agent C,

optionally in the presence of a catalytically active component D,

wherein production is carried out at an index of 150 to 600, preferably 240 to 400.

It has surprisingly been found that the component A according to the invention has made it possible to provide a formulation containing high molecular weight polyester building blocks which nevertheless has a low viscosity and is processable into rigid PUR/PIR foams having a good cell structure. The polyesters produced with component A according to the invention also have good flame retardancies and improved mechanical properties, such as tensile strength, breaking elongation, toughness and open-cell content of the rigid PUR/PIR foams.

### DETAILED DESCRIPTION

The polyester polyol component A1-1 is a polyester polyol having an OH number ≤240 mg KOH/g, preferably ≤200 mg KOH/g, a functionality of 1.5-2.5 and a content of free glycols of molar mass <150 g/mol of less than 6% by weight based on the total mass of A1-1. Due to its molecular weight such a polyol component typically has a viscosity which is high for rigid PUR/PIR foam applications, in particular a viscosity of >5 Pa*s.

The proportion of polyester polyols A1-1 in the polyester polyol component A1 is preferably >60% by weight, in particular ≥80% by weight and very particularly preferably ≥90% by weight. The mass ratio of A1-1 to A1-2 is therefore preferably at least 6:1, in particular at least 8:1.

Polyester polyols having a low content of free glycols are known per se and their preparation and use in CFC-based PUR/PIR formulations is disclosed for example in U.S. Pat. No. 5,109,301.

The polyester polyols of component A1 may be for example polycondensates of polyhydric alcohols, preferably diols, having 2 to 12 carbon atoms, preferably having 2 to 6 carbon atoms, and polycarboxylic acids, for example di-, tri- or even tetracarboxylic acids or hydroxycarboxylic acids or lactones, and it is preferable to employ aromatic dicarboxylic acids or mixtures of aromatic and aliphatic dicarboxylic acids. Instead of the free polycarboxylic acids, it is also possible to use the corresponding polycarboxylic anhydrides or corresponding polycarboxylic esters of lower alcohols for producing the polyesters. It is preferable to use phthalic anhydride, terephthalic acid and/or isophthalic acid.

Contemplated carboxylic acids especially include: succinic acid, glutaric acid, adipic acid, suberic acid, azelaic acid, sebacic acid, decanedicarboxylic acid, tetrahydrophthalic acid, hexahydrophthalic acid, cyclohexanedicarboxylic acid, tetrachlorophthalic acid, itaconic acid, malonic acid, furandicarboxylic acids, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, trimellitic acid, benzoic acid, trimellitic acid, maleic acid, fumaric acid, phthalic acid, isophthalic acid and terephthalic acid. It is likewise possible to use derivatives of these carboxylic acids, for example dimethyl terephthalate. The carboxylic acids may be used both singly and in admixture. Preferably employed as carboxylic acids are adipic acid, sebacic acid and/or succinic acid, particularly preferably adipic acid and/or succinic acid.

Hydroxycarboxylic acids that may be co-employed as reaction participants in the preparation of a polyester polyol having terminal hydroxyl groups are for example hydroxycaproic acid, hydroxybutyric acid, hydroxydecanoic acid, hydroxystearic acid and the like. Suitable lactones are inter alia caprolactone, propiolactone butyrolactone and homologs.

Also especially useful for preparation of the polyester polyols are bio-based starting materials and/or derivatives thereof, for example castor oil, polyhydroxy fatty acids, ricinoleic acid, hydroxyl-modified oils, grapeseed oil, black cumin oil, pumpkin seed oil, borage seed oil, soybean oil, wheat germ oil, rapeseed oil, sunflower seed oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, fatty acids, hydroxyl-modified and epoxidized fatty acids and fatty acid esters, for example based on myristoleic acid, palmitoleic acid, oleic acid, vaccenic acid, petroselic acid, gadoleic acid, erucic acid, nervonic acid, linoleic acid, alpha- and gamma-linolenic acid, stearidonic acid, arachidonic acid, timnodonic acid, clupanodonic acid and cervonic acid. Particular preference is given to esters of ricinoleic acid with polyfunctional alcohols, for example glycerol. Preference is also given to the use of mixtures of such bio-based acids with other carboxylic acids, for example phthalic acids.

Examples of suitable diols are ethylene glycol, butylene glycol, diethylene glycol, triethylene glycol, polyalkylene glycols such as polyethylene glycol, and also 1,2-propanediol, 1,3-propanediol, cyclohexanedimethanol, 1,3-butanediol, 1,4-butanediol, 1,6-hexanediol and isomers, neopentyl glycol or neopentyl glycol hydroxypivalate. Preference is given to using ethylene glycol, diethylene glycol, butane-1,4-diol, pentane-1,5-diol, hexane-1,6-diol or mixtures of at least two of the diols mentioned, in particular mixtures of butane-1,4-diol, pentane-1,5-diol and hexane-1,6-diol.

It is additionally also possible to use polyols such as trimethylolpropane, glycerol, erythritol, pentaerythritol, trimethylolbenzene or trishydroxyethyl isocyanurate, wherein glycerol and trimethylolpropane are preferred.

In addition, monohydric alkanols can additionally also be co-used.

Polyester polyols comprising polyether structures may also be used in the polyester polyol component. These are often also referred to as “polyether ester polyols”. Employable polyether ester polyols are compounds containing ether groups, ester groups and OH groups. Organic dicarboxylic acids having up to 12 carbon atoms are suitable for preparing the polyether ester polyols, preferably aliphatic dicarboxylic acids having 4 to 6 carbon atoms or aromatic dicarboxylic acids used singly or in admixture. Examples include suberic acid, azelaic acid, decanedicarboxylic acid, furandicarboxylic acid, maleic acid, malonic acid, phthalic acid, pimelic acid and sebacic acid and in particular glutaric acid, fumaric acid, succinic acid, adipic acid, phthalic acid, terephthalic acid and isoterephthalic acid. In addition to organic dicarboxylic acids, derivatives of these acids can also be used, for example their anhydrides and also their esters and half-esters with low molecular weight monofunctional alcohols having 1 to 4 carbon atoms. The use of proportions of the abovementioned bio-based starting materials, in particular of fatty acids/fatty acid derivatives (oleic acid, soybean oil etc.), is likewise possible and can have advantages, for example in respect of storage stability of the polyol formulation, dimensional stability, fire behavior and compressive strength of the foams.

Polyether polyols obtained by alkoxylation of starter molecules such as polyhydric alcohols are a further component used for preparing polyether ester polyols. The starter molecules are at least difunctional, but can optionally also comprise portions of starter molecules which have higher functionality, in particular which are trifunctional.

Starter molecules include for example diols such as 1,2-ethanediol, 1,3-propanediol, 1,2-propanediol, 1,4-butanediol, 1,5-pentenediol, 1,5-pentanediol, neopentyl glycol, 1,6-hexanediol, 1,7-heptanediol, 1,8-octanediol, 1,10-decanediol, 2-methyl-1,3-propanediol, 2,2-dimethyl-1,3-propanediol, 3-methyl-1,5-pentanediol, 2-butyl-2-ethyl-1,3-propanediol, 2-butene-1,4-diol and 2-butyne-1,4-diol, ether diols such as diethylene glycol, triethylene glycol, tetraethylene glycol, dibutylene glycol, tributylene glycol, tetrabutylene glycol, dihexylene glycol, trihexylene glycol, tetrahexylene glycol and oligomeric mixtures of alkylene glycols, such as diethylene glycol. Starter molecules having functionalities other than OH can also be used alone or in a mixture.

In addition to the diols, starter molecules used for preparing the polyethers may also be compounds having more than 2 Zerewitinoff-active hydrogens, particularly having number-average functionalities of 3 to 8, in particular of 3 to 6, for example 1,1,1-trimethylolpropane, triethanolamine, glycerol, sorbitan and pentaerythritol and also triol- or tetraol-started polyethylene oxide polyols.

Polyether ester polyols may also be prepared by the alkoxylation, in particular by ethoxylation and/or propoxylation, of reaction products obtained by the reaction of organic dicarboxylic acids and their derivatives and components with Zerewitinoff-active hydrogens, in particular diols and polyols. Derivatives of these acids that may be employed include for example their anhydrides, for example phthalic anhydride.

Employed as component A2 are polyethylene glycols, i.e. reaction products of a low molecular weight 2-3-functional hydroxy-functional starter molecule with ethylene oxide, wherein the ethylene oxide accounts for 80% of the molar weight. The starter molecules are in particular water, ethylene glycol, diethylene glycol, propylene glycol, glycerol and/or trimethylolpropane. The preparation of such polyethylene glycols is known to those skilled in the art and many of these substances are commercially available. Suitable polyethylene glycols are preferably liquid at 298 K and in particular have molecular weights of ≤700 g/mol and an average functionality <2.5, especially preferably have an average molar weight of 200-600 g/mol and very particularly preferably an average functionality of ≤2.12.

The other isocyanate-reactive components A3 are for example polyols, such as polyether polyols, polycarbonate polyols and polyether-polycarbonate polyols, which do not fall under the definition of the components A1 and A2.

The addition of long-chain polyols, in particular polyether polyols, can bring about the improvement in the flowability of the reaction mixture and the emulsifiability of the blowing agent-containing formulation. For the production of composite elements these can allow for example continuous production of elements with flexible or rigid outer layers.

In a preferred embodiment long-chain polyols have functionalities of ≥1.2 to ≤3.5 and have a hydroxyl number between 10 and 100 mg KOH/g, preferably between 20 and 50 mg KOH/g, and have more than 70 mol%, preferably more than 80 mol%, in particular more than 90 mol%, of primary OH groups. The long-chain polyols are preferably polyether polyols having functionalities of ≥1.2 to ≤3.5 and a hydroxyl number between 10 and 100 mg KOH/g.

The addition of medium-chain polyols, in particular polyether polyols, and low molecular weight isocyanate-reactive compounds can bring about the improvement in the adhesion and dimensional stability of the resulting foam. For the production of composite elements with the process according to the invention these medium-chain polyols can allow continuous production of elements with flexible or rigid outer layers. The medium-chain polyols, which are in particular polyether polyols, have functionalities of ≥2 to ≤6 and have a hydroxyl number between 300 and 700 mg KOH/g.

The polyether polyols used are the polyether polyols employable in polyurethane synthesis, known to those skilled in the art and having the features mentioned.

Examples of polyether polyols that can be used are polytetramethylene glycol polyethers of the type obtainable via polymerization of tetrahydrofuran by means of cationic ring-opening.

Polyether polyols are obtained by methods of preparation known to those skilled in the art, such as for example by anionic polymerization of one or more alkylene oxides having 2 to 4 carbon atoms with alkali metal hydroxides, such as sodium or potassium hydroxide, alkali metal alkoxides, such as sodium methoxide, sodium or potassium ethoxide or potassium isopropoxide, or aminic alkoxylation catalysts, such as dimethylethanolamine (DMEOA), imidazole and/or imidazole derivatives, using at least one starter molecule containing 2 to 8, preferably 2 to 6, reactive hydrogen atoms in bonded form.

Suitable alkylene oxides are for example tetrahydrofuran, 1,3-propylene oxide, 1,2- and 2,3-butylene oxide, styrene oxide and preferably ethylene oxide and 1,2-propylene oxide. The alkylene oxides may be used singly, alternately in succession or as mixtures. Preferred alkylene oxides are propylene oxide and ethylene oxide and ethylene oxide is particularly preferred. The alkylene oxides may be reacted in combination with CO₂.

Contemplated starter molecules include for example: water, organic dicarboxylic acids, such as succinic acid, adipic acid, phthalic acid and terephthalic acid, aliphatic and aromatic, optionally N-mono-, N,N- and N,N′-dialkyl-substituted diamines having 1 to 4 carbon atoms in the alkyl radical, such as optionally mono- and dialkyl-substituted ethylenediamine, diethylenetriamine, triethylenetetramine, 1,3-propylenediamine, 1,3- and 1,4-butylenediamine, 1,2-, 1,3-, 1,4-, 1,5- and 1,6-hexamethylenediamine, phenylenediamines, 2,3-, 2,4- and 2,6-tolylenediamine and 2,2′-, 2,4′- and 4,4′-diaminodiphenylmethane.

Preference is given to using dihydric or polyhydric alcohols such as ethanediol, propane-1,2- and -1,3-diol, diethylene glycol, dipropylene glycol, butane-1,4-diol, hexane-1,6-diol, triethanolamine, bisphenols, glycerol, trimethylolpropane, pentaerythritol, sorbitol and sucrose.

Polycarbonate polyols that may be used are polycarbonates having hydroxyl groups, for example polycarbonate diols. These are formed in the reaction of carbonic acid derivatives, such as diphenyl carbonate, dimethyl carbonate or phosgene, with polyols, preferably diols.

Examples of such diols are ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenols, and lactone-modified diols of the abovementioned type. It is also possible to use, instead of or in addition to pure polycarbonate diols, polyether polycarbonate diols which for example are obtainable via copolymerization of alkylene oxides, for example propylene oxide, with CO₂.

Processes for preparing the polyols have been described for example by Ionescu in “Chemistry and Technology of Polyols for Polyurethanes”, Rapra Technology Limited, Shawbury 2005, p. 55 et seq. (chapt. 4: Oligo-Polyols for Elastic Polyurethanes), p. 263 et seq. (chapt. 8: Polyester Polyols for Elastic Polyurethanes) and in particular on p. 321 et seq. (chapt. 13: Polyether Polyols for Rigid Polyurethane Foams) and p. 419 et seq. (chapt. 16: Polyester Polyols for Rigid Polyurethane Foams). It is also possible to obtain polyester polyols and polyether polyols by glycolysis of suitable polymer recyclates. Suitable polyether polycarbonate polyols and the preparation thereof are described, for example, in EP 2 910 585 A1, [0024]-[0041]. Examples of polycarbonate polyols and the preparation thereof can be found, inter alia, in EP 1 359 177 A1. The preparation of suitable polyetherester polyols has been described, inter alia, in WO 2010/043624 A and in EP 1 923 417 A.

If low molecular weight isocyanate-reactive compounds are used for producing the rigid PUR/PIR foams, for example as chain extenders and/or crosslinking agents, these are expediently employed in an amount of at most 6% by weight based on the total weight of the polyol formulation A. Compounds which on account of their structure fall not only under the definition of component A3 but also under one of the definitions of the above-described polyol compounds A1 or A2 are accounted as belonging to the component A1 or A2 and not to the component A3.

The mixture of the polyols A1 and A2 preferably has a viscosity ≤4 Pa*s, in particular a viscosity of 2-4 Pa*s.

The mixture of the polyols A1 and A2 preferably has an OH number of 260 mg KOH/g, in particular of 230 mg KOH/g.

The mass ratio of polyester polyols A1 to polyethylene glycols A2 in the polyol formulation is preferably 2-10.

In the context of the present application the singular designation of the components—“polyol”, “polyester polyol”, etc.—is to be understood in each case as meaning the mixture of all components falling under the respective definition.

The compounds A4 are one or more compounds selected from the group consisting of
A4 0.2-5% by weight, based on the polyol formulation A, of one or more compounds selected from the group consisting of
   A4-1 a polyethylene glycol 2,4,6-trialkylphenyl ether (structure I where R5, R6, R7=H, C1- to C8-alkyl) and
   A4-2 polyethylene glycol 2,4,6-triaralkylphenyl ethers (structure I where R5, R6 and/or R7=aryl) and
   A4-3 polyethylene glycol alkyl phenyl ethers (structure II)

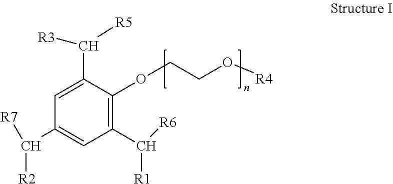

R1, R2, R3, R4=H, C1-C4-alkyl,
R5, R6, R7=H, C1- to C8-alkyl, aryl
n=7-20, preferably 10-18, particularly preferably 11-15

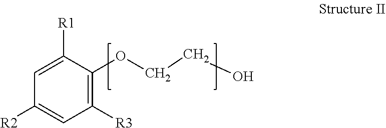

R1, R3=H, C(CH₃)₂CR4R5R6
R2=C(CH₃)₂CR4R5R6
R4, R5=H or CH₃
R6=C2- to C5-alkyl, aryl
n=3-8
wherein the compounds A4 have a molar weight of less than 1.5 kg/mol and a content of 25-70% ethylene oxide, preferably 40-60% ethylene oxide.

wherein the compounds A4 have a molar weight of less than 1.5 kg/mol and a content of 25-70% ethylene oxide, preferably 40-60% ethylene oxide.

Preferred compounds A4 are shown in Table 1 and are those of structure IV (falls under the definition of compounds A4-2), structure V (falls under the definition of compounds A4-1) and structure VI (falls under the definition of compounds A4-3).

TABLE 1

| | 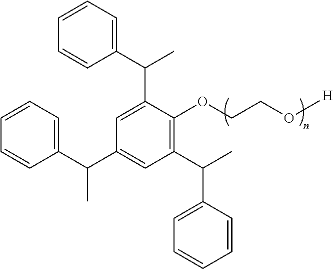 Structure IV | 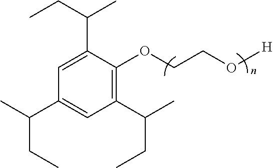 Structure V |
|---|---|---|
| IUPAC | α-[2,4,6-tris(1-phenylethyl)phenyl]-ω- | α-[2,4,6-tris(1-methylpropyl)phenyl]-ω- |
| | hydroxypoly(oxy-1,2-ethanediyl) | hydroxy-poly(oxy-1,2-ethanediyl) |
| CAS number | 70559-25-0 | 31800-76-7 |
| Other names | Polyethylene glycol 2,4,6-tristyrylphenyl ether | Polyethylene glycol mono(2,4,6-tri-sec-butylphenyl) |
| | | ether |
| Trade names | Emulsogen TS100, TS160, TS290, TS600 (Clariant) | Sapogenat T110 (Clariant) |

| | 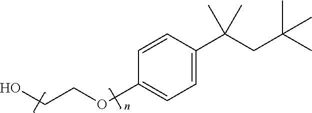 Structure VI |
|---|---|
| IUPAC | α-[4-(1,1,3,3-tetramethylbutyl)phenyl]-ω- |
| | hydroxy-poly(oxy-1,2-ethanediyl), |
| CAS number | 9002-93-1 |
| Other names | Polyethylene glycol mono(p-tert-octylphenyl) ether |
| Trade names | Triton X45 |

Optionally also employable in addition to the compounds A4 are one or more further additives as component A5. Examples of component A5 are surface-active substances, foam stabilizers, cell regulators, flame retardants, fillers, dyes, pigments, hydrolysis stabilizers, fungistatic and bacteriostatic substances.

Contemplated surface-active substances include for example compounds that serve to promote the homogenization of the starting substances and are optionally also suitable for regulating the cell structure of the plastics. Examples include emulsifiers, such as the sodium salts of castor oil sulfates or of fatty acids and salts of fatty acids with amines, for example diethylamine oleate, diethanolamine stearate, diethanolamine ricinoleate, salts of sulfonic acids, for example alkali metal or ammonium salts of dodecylbenzenedisulfonic acid or dinaphthylmethanedisulfonic acid and ricinoleic acid; foam stabilizers, such as siloxane oxyalkylene mixed polymers and other organopolysiloxanes, ethoxylated alkylphenols distinct from A4, ethoxylated fatty alcohols, paraffin oils, castor oil esters or ricinoleic esters, Turkey red oil and peanut oil, and cell regulators, such as paraffins, fatty alcohols and dimethylpolysiloxanes. The above-described oligomeric acrylates having polyoxyalkylene and fluoroalkane radicals as side groups are also suitable for improving emulsifying action, cell structure and/or stabilization of the foam. Emulsifiers whose structure falls under the definition of the component A4 are also accounted as belonging to the component A4 and not to the component A5.

Fillers, in particular reinforcing fillers, include the customary organic and inorganic fillers, reinforcers, weighting agents, agents for improving abrasion characteristics in paints, coating agents etc. which are known per se. These especially include for example: inorganic fillers such as siliceous minerals, for example phyllosilicates such as for example antigorite, serpentine, sepiolite, hornblendes, amphiboles, chrysotile, montmorillonite and talc, metal oxides such as kaolin, aluminum oxides, titanium oxides and iron oxides, metal salts, such as chalk, huntite, barite and inorganic pigments, such as magenetite, goethite, cadmium sulfide and zinc sulfide and also glass inter alia, and natural and synthetic fibrous minerals such as wollastonite, metal fibers and in particular glass fibers of various lengths which may optionally have been coated with a size. Examples of contemplated organic fillers include: carbon, melamine, colophony, cyclopentadienyl resins and graft polymers and also cellulose fibers, polyamide fibers, polyacrylonitrile fibers, polyurethane fibers and polyester fibers based on aromatic and/or aliphatic dicarboxylic esters and carbon fibers.

To produce the rigid PUR/PIR foams it is preferable to also employ a flame retardant A5.

Flame retardants are known in principle to the person skilled in the art and are described, for example, in “Kunststoffhandbuch”, volume 7 “Polyurethane”, chapter 6.1. These may be for example halogenated polyesters and polyols, brominated and chlorinated paraffins or phosphorus compounds, such as for example the esters of orthophosphoric acid and of metaphosphoric acid, which may likewise contain halogen. It is preferable to choose flame retardants that are liquid at 298 K. Examples include triethyl phosphate, diethylethane phosphonate, cresyldiphenyl phosphate and other triarylphosphates, dimethylpropane phosphonate, hydroxymethylphosphonates and tris(β-chloroisopropyl) phosphate. Flame retardants selected from the group consisting of tris(chloro-2-propyl) phosphate (TCPP) and triethyl phosphate (TEP) and mixtures thereof are particularly preferred. It is preferable to employ flame retardants in an amount of 1% to 30% by weight, particularly preferably 5% to 30% by weight, based on the total weight of the isocyanate-reactive composition A) so as to achieve a phosphorus content in the foam of 0.4-1.3% by weight. It may also be advantageous to combine different flame retardants with one another to achieve particular profiles of properties (viscosity, brittleness, flammability, halogen content etc.). In certain embodiments the presence of triethyl phosphate (TEP) in the flame retardant mixture or as the sole flame retardant is particularly advantageous.

The polyol formulation further contains A6 not more than 2% by weight, preferably not more than 2.0% by weight, particularly preferably not more than 1.2% by weight, of water based on the total mass of the polyol formulation A.

In the context of the present invention the number-average molar mass Mₐ(also known as molecular weight) is determined by gel permeation chromatography according to DIN 55672-1 (August 2007).

In the case of a single added polyol the OH number (also known as hydroxyl number) specifies the OH number of said polyol. Reported OH numbers for mixtures relate to the number-average OH number of the mixture calculated from the OH numbers of the individual components in their respective molar proportions. The OH number indicates the amount of potassium hydroxide in milligrams which is equivalent to the amount of acetic acid bound by one gram of substance during acetylation. In the context of the present invention the OH number is determined according to the standard DIN 53240-1 (June 2013).

In the context of the present invention “functionality” refers to the theoretical average functionality (number of isocyanate-reactive or polyol-reactive functions in the molecule or averaged over the respective mixture of the molecules) calculated from the known input materials and their quantitative ratios.

The equivalent weight specifies the ratio of the number-average molecular mass and the functionality of the isocyanate-reactive component. The reported equivalent weights for mixtures are calculated from equivalent weights of the individual components in their respective molar proportions and relate to the number-average equivalent weight of the mixture.

Employable blowing agents C include physical blowing agents such as for example low-boiling organic compounds, for example, hydrocarbons, halogenated hydrocarbons, ethers, ketones, carboxylic esters or carbonic esters. Organic compounds inert towards the isocyanate component B and having boiling points below 100° C., preferably below 50° C., at atmospheric pressure are suitable in particular. These boiling points have the advantage that the organic compounds evaporate under the influence of the exothermic polyaddition reaction. Examples of such preferably used organic compounds are alkanes, such as heptane, hexane, n-pentane and isopentane, preferably technical grade mixtures of n-pentane and isopentane, n-butane and isobutane and propane, cycloalkanes, such as for example cyclopentane and/or cyclohexane, ethers, such as for example furan, dimethyl ether and diethyl ether, ketones, such as for example acetone and methyl ethyl ketone, alkyl carboxylates, such as for example methyl formate, dimethyl oxalate and ethyl acetate and halogenated hydrocarbons, for example methylene chloride, difluoromethane, trifluoromethane, difluoroethane, tetrafluoroethane and heptafluoropropane. It is preferable to employ no blowing agents known to have an adverse effect on the Earth's ozone layer. Also preferred is the use of (hydro)fluorinated olefins, for example HFO 1233zd(E) (trans-l-chloro-3,3,3-trifluoro-l-propene) or HFO 1336mzz(Z) (cis-1,1,1,4,4,4-hexafluoro-2-butene) or additives such as FA 188 from 3M (1,1,1,2,3,4,5,5,5-nonafluoro-4-(trifluoromethyl)pent-2-ene). Mixtures of two or more of the recited organic compounds may also be employed. The organic compounds may also be used here in the form of an emulsion of small droplets.

Employable blowing agents C further include chemical blowing agents, for example water, carboxylic acid and mixtures thereof. These react with isocyanate groups to form the blowing gas, forming carbon dioxide for example in the case of water and forming carbon dioxide and carbon monoxide for example in the case of formic acid. The carboxylic acid used is preferably at least one compound selected from the group consisting of formic acid, acetic acid, oxalic acid and ricinoleic acid. A particularly preferred chemical blowing agent is water.

Halogenated hydrocarbons are preferably not used as blowing agent.

At least one compound selected from the group consisting of physical and chemical blowing agents is employed as blowing agent C. Preference is given to using only physical blowing agent. In a preferred embodiment the employed blowing agents C have an average global warming potential (GWP) of <120, preferably a GWP of <20.

Employed catalysts D for producing the PUR/PIR foams are compounds which accelerate the reaction of the compounds containing reactive hydrogen atoms, in particular hydroxyl groups, with the isocyanate component B, such as for example tertiary amines or metal salts. The catalyst components may be metered into the reaction mixture or else completely or partially initially charged in the polyol formulation A.

Compounds employed are for example tertiary amines, such as triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methyl- or N-ethylmorpholine, N-cyclohexylmorpholine, N,N,N′,N′-tetramethylethylenediamine, N,N,N,N-tetramethylbutanediamine, N,N,N,N-tetramethylhexane-1,6-diamine, pentamethyldiethylenetriamine, bis [2-(dimethylamino)ethyl] ether, dimethyl piperazine, N-dimethylaminoethylpiperidine, 1,2-dimethylimidazole, 1-azabicyclo [3,3,0]octane, 1,4-diazabicyclo[2,2,2]octane (Dabco) and alkanolamine compounds such as triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazine, for example N,N′,N″-tris(dimethylaminopropyl)hexahydrotriazine and triethylenediamine.

Metal salts, for example alkali metal or transition metal salts, may also be used. Transition metal salts used are for example zinc salts, bismuth salts, iron salts, lead salts or preferably tin salts. Examples of transition metal salts used are iron(II) chloride, zinc chloride, lead octoate, tin dioctoate, tin diethylhexoate and dibutyltin dilaurate. The transition metal salt is particularly preferably selected from at least one compound from the group consisting of tin dioctoate, tin diethylhexoate and dibutyltin dilaurate. Examples of alkali metal salts are alkali metal alkoxides such as for example sodium methoxide and potassium isopropoxide, alkali metal carboxylates such as for example potassium acetate, and also alkali metal salts of long-chain fatty acids having 10 to 20 carbon atoms and optionally pendant OH groups. It is preferable to employ one or more alkali metal carboxylates as the alkali metal salt.

Contemplated catalysts D further include: amidines, for example 2,3-dimethyl-3,4,5,6-tetrahydropyrimidine, tetraalkylammonium hydroxides, for example tetramethylammonium hydroxide, alkali metal hydroxides, for example sodium hydroxide, and tetraalkylammonium carboxylates or phosphonium carboxylates Mannich bases and salts of phenols are also suitable catalysts. It is also possible to perform the reactions without catalysis. In this case the catalytic activity of amine-started polyols is utilized.

If a relatively large polyisocyanate excess is used when foaming, contemplated catalysts for the trimerization reaction of the excess NCO groups with one another further include: isocyanurate group-forming catalysts, for example ammonium ion salts or alkali metal salts, especially ammonium carboxylates or alkali metal carboxylates, alone or in combination with tertiary amines. Isocyanurate formation results in particularly flame-retardant rigid PIR foams.

The catalyst components may be metered into the reaction mixture or else completely or partially initially charged in the polyol formulation A.

The reactivity of the reaction mixture is usually adapted to the requirements by means of the catalyst component. Production of thin panels thus requires a reaction mixture having a higher reactivity than production of thicker panels. Cream time and fiber time are respectively typical parameters for the time taken for the reaction mixture to begin to react and for the point at which a sufficiently stable polymer network has been formed.

The abovementioned catalysts may be used alone or in combination with one another. Contemplated suitable isocyanate components B are for example polyisocyanates, i.e. isocyanates having an NCO functionality of at least 2. Examples of such suitable polyisocyanates are 1,4-butylene diisocyanate, 1,5-pentanediisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI) and also alkyl 2,6-diisocyanatohexanoates (lysine diisocyanates) having C1- to C6-alkyl groups. The isocyanate component B is preferably selected from at least one compound from the group consisting of MDI, polymeric MDI and TDI.

In addition to the abovementioned polyisocyanates, it is also possible to co-use proportions of modified diisocyanates having a uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

Also employable as the isocyanate component B instead of or in addition to the abovementioned polyisocyanates are suitable NCO prepolymers. The prepolymers are preparable by reaction of one or more polyisocyanates with one or more polyols corresponding to the polyols described under the isocyanate-reactive components A1.

For use as the polyisocyanate component polymeric MDI types are particularly preferred over monomeric isocyanates in rigid foam.

The NCO content of the polyisocyanate component A) is preferably from ≥29.0% by weight to ≤33.0% by weight and preferably has a viscosity at 25° C. of ≥80 mPas to ≤2900 mPas, particularly preferably of ≥95 mPas to ≤850 mPas at 25° C.

The NCO value (also known as NCO content, isocyanate content) is determined according to EN ISO 11909:2007. The values are at 25° C. unless stated otherwise.

Reported viscosities are dynamic viscosities at 25° C. (unless otherwise stated) determined according to DIN EN ISO 3219:1994-10 “Plastics—Polymers/Resins in the liquid State or as Emulsions or Dispersions”.

The isocyanate index (also known as the index) is to be understood as meaning the quotient of the actually employed amount of substance [mol] of isocyanate groups and the actually employed amount of substance [mol] of isocyanate-reactive groups, multiplied by 100:

index=(moles of isocyanate groups/moles of isocyanate-reactive groups)*100

According to the invention the index in the reaction mixture is 150 to 600, preferably 240 to 400. This index is particularly preferably in a range from 240 to 400 in which a high proportion of polyisocyanurates (PIR) is present (the foam is referred to as a PIR foam or PUR/PIR foam) and results in a higher flame retardancy of the PUR/PIR foam itself.

The NCO value (also known as NCO content, isocyanate content) is determined according to EN ISO 11909 (May 2007). The values are at 25° C. unless stated otherwise.

The invention likewise relates to a rigid PUR/PIR foam produced by the process according to the invention.

The components A-D are mixed to produce a reaction mixture which results in the PUR/PIR foam. Production is generally carried out by mixing of all components via customary high- or low-pressure mixing heads.

The rigid PUR/PIR foams according to the invention are produced by one-step processes known to those skilled in the art and in which the reaction components are continuously or discontinuously reacted with one another and then subsequently introduced either manually or with the aid of mechanical equipment in the high-pressure or low-pressure process after discharge onto a conveyor belt or into suitable molds for curing.

The rigid PUR/PIR foams according to the invention are preferably used for producing composite elements. Foaming is typically carried out here in continuous or discontinuous fashion against at least one outer layer.

The invention accordingly further provides for the use of a rigid PUR/PIR foam according to the invention as an insulation foam and/or as an adhesion promoter in composite elements, wherein the composite elements comprise a layer comprising a rigid PUR/PIR foam according to the invention and at least one outer layer. The outer layer is in this case at least partially contacted by a layer comprising the rigid PUR/PIR foam according to the invention. Composite elements of the type of interest here are also known as sandwich elements or insulation panels and are generally used as building elements for soundproofing, insulation, for commercial buildings or for façade construction. The outer layers may be formed for example by sheets of metal, sheets of plastics or particleboards of up to 7 mm in thickness depending on the application of the composite elements. The one or two outer layers may in each case be a flexible outer layer, for example made of an aluminum foil, paper, multilayer outer layers made of paper and aluminum or of mineral nonwovens and/or a rigid outer layer, for example made of sheet steel or particleboard.

### EXAMPLES

Input materials:

| | |
|---|---|
| A1-1-a | Aromatic/aliphatic polyester, f = 2, contains |
| | 1.5% by weight of free ethylene glycol, 2.4% |
| | by weight of free diethylene glycol (according |
| | to Monte Carlo calculation), OH number 195 |
| | mg KOH/g, acid number 0.55 mg KOH/g. |
| A2-a | Polyethylene glycol PEG 400, viscosity |
| | 0.12 Pa*s (25° C.) |
| A2-b | Reaction product of trimethylolpropane and |
| | ethylene oxide in an OH: ethylene oxide molar |
| | ratio of 1:4. The OH number is 250 mg |
| | KOH/g, the viscosity is 0.37 Pa*s at 25° C. |
| A3-a | Reaction product of phthalic anhydride and |
| | diethylene glycol in a molar ratio of 1:1 |
| A4-1-a | Polyethylene glycol mono(2,4,6-tri-sec- |
| | butylphenyl)ether (structure I where n = 11, |
| | R1 = R2 = R3 = CH₃, R4 = H, R5 = R6 = R7 = |
| | C₂H₅; 67% by weight of ethylene oxide; HLB = 13) |
| A4-2-a | Polyethylene glycol 2,4,6-tristyrylphenyl ether |
| | (n = 10, R1 = R2 = R3 = CH₃, R4 = H, R5 = R6 = |
| | R7 = C₆H₅; 54% by weight ethylene oxide; HLB = 10) |
| A4-2-b | Polyethylene glycol 2,4,6-tristyrylphenyl ether |
| | (n = 16, R1 = R2 = R3 = CH₃, R4 = H, R5 = R6 = |
| | R7 = C₆H₅, 65% by weight ethylene oxide; HLB = 13) |
| A4-2-c | Polyethylene glycol 2,4,6-tristyrylphenyl ether |
| | (n = 29, R1 = R2 = R3 = CH₃, R4 = H, R5 = R6 = |
| | R7 = C₆H₅, 77% by weight ethylene oxide; HLB = 15) |
| A4-2-d | Polyethylene glycol 2,4,6-tristyrylphenyl ether |
| | (n = 60, R1 = R2 = R3 = CH₃, R4 = H, R5 = R6 = |
| | R7 = C₆H₅, 87% by weight ethylene oxide; HLB = 17) |
| A5-a | Polyether modified oligodimethylsiloxane |
| A5-b | Mixture of Levagard ® PP and Levagard ® TEP |
| | in a weight ratio of 4:1 (both Lanxess AG) |
| B-a | polymeric MDI having a viscosity of 700 mPas at |
| | 25° C. and an NCO content of 31.5% by weight |
| | (Desmodur ^{®} 44V70L, Covestro Deutschland AG) |
| C-a | n-Pentane |
| D-a | 25% by weight potassium acetate in diethylene glycol |

Production and Testing of Rigid PUR/PIR Foams

The flame spread of the rigid PUR/PIR foams was measured by edge flaming with the small burner test according to DIN 4102-1 (May 1998) on a sample having dimensions of 18 cm x 9 cm x 2 cm. The value for the maximum vertical flame height in cm is reported.

The maximum average rate of heat emission (MARHE), the CO yield and the specific light absorption area SEA as a measure of smoke gas density were measured according to ISO standard 5660-1:1990 with a “cone calorimeter”. The test specimens measuring 1 dm×1 dm×0.3 dm are irradiated for 20 minutes at 50 kW/m2 using a heat radiator. The determined CO yield indicates the average value from two measurements.

The OH number (hydroxyl number) was determined according to DIN 53240-1 (June 2013).

The acid number was determined according to DIN EN ISO 2114 (November 2006).

Viscosity was determined on an Anton Paar Physica MCR 501 rheometer. A cone-plate configuration having a separation of 1 mm was selected (DCP25 measurement system). The polyol (0.1 g) was applied to the rheometer plate and subjected to a shear of 0.01 to 1000 1/s at 25° C. and the viscosity was measured every 10 s for 10 min. What is reported is the viscosity averaged over all measurement points.

The open-cell content of the rigid PUR/PIR foams was measured with an Accupyk-1330 instrument on test specimens having dimensions of 5 cm x 3 cm x 3 cm according to DIN EN ISO 4590 (August 2003).

Compressive strength in the rise direction was measured according to DIN ISO 826 (May 2013)

The cell structure of the foam was determined by visual inspection.

Measurement of apparent density was performed according to DIN EN ISO 845 (October 2009).

Tensile tests according to DIN 53430 (September 1975) were used to determine tensile strength (σ_{Fmax}), breaking elongation (ε_{breaking}) and a measure of toughness (σ_{Fmax}*ε_{breaking}/2) on tensile bars (machined according to DIN 53430 5.1).

Formulations

The respective polyol formulations were obtained from a base polyol component containing

46 parts by weight A1-1-a

5 parts by weight A2-b

2 parts by weight A3-a

4 parts by weight A5-a

25 parts by weight A5-b.

The base polyol component already further contains 5 parts by weight of the catalyst D-a.

To produce the different PUR-PIR foams, the base polyol component was admixed with the respective further polyol components according to table 2 and n-pentane as blowing agent in a paper cup.

PUR/PIR Foams

The obtained isocyanate-reactive mixture was mixed with the isocyanate and the reaction mixture was poured into a paper mold (3×3×1 dm³) and reacted therein. The exact formulations of the individual experiments are reported in the tables which follow, as are the results of the physical measurements on the samples obtained.

The reaction parameters and the foam properties are reported in Table 4.

The inventive examples 3-5 are superior to the noninventive comparative examples 1*, 2*, 6* and 7* inter alia in the combination of the properties of good flame retardancy and cell structure.

TABLE 2

| Examples (* are comparative examples) | | 1* | 2* | 3 | 4 | 5 | 6* | 7* |
|---|---|---|---|---|---|---|---|---|
| Base polyol component | parts by wt. | 87 | 87 | 87 | 87 | 87 | 87 | 87 |
| A2-a | parts by wt. | 0 | 16 | 16 | 16 | 16 | 16 | 16 |
| A 1 -1-a | parts by wt. | 18 | 2 | | | | | |
| A4-1-a/11 EO | parts by wt. | | | 2 | | | | |
| A4-2a/12 EO | parts by wt. | | | | 2 | | | |
| A4-2b/16 EO | parts by wt. | | | | | 2 | | |
| A4-2c/29 EO | parts by wt. | | | | | | 2 | |
| A4-2d/60 EO | parts by wt. | | | | | | | 2 |
| D-a | parts by wt. | 19 | 19 | 19 | 19 | 19 | 19 | 19 |
| Ba | parts by wt. | 150 | 160.5 | 157.5 | 157.5 | 157.5 | 157.5 | 157.5 |
| Index | | 320 | 320 | 320 | 320 | 320 | 320 | 320 |
| Average functionality of all polyethylene oxides A2-a and A2- | | 3.00 | 2.16 | 2.16 | 2.16 | 2.16 | 2.16 | 2.16 |
| b | | | | | | | | |
| Viscosity of polyol mixture A1-1-a, A2-a and A2-b (¹) | Pa*s | 8.8 | 3.0 | 3.0 | 3.0 | 3.0 | 3.0 | 3.0 |
| OH number of mixture of A1-1-a, A2a and A2b (²) | mg KOH/g | 198 | 218 | 219 | 219 | 219 | 219 | 219 |
| Ratio A 1:A2 | | 12.8 | 2.3 | 2.0 | 2.0 | 2.0 | 2.0 | 2.0 |

¹ calculated according to ln(viscosity of polyol mixture) = proportion A1-1-a in the mixture × In(viscosity A1-1-a) + proportion A2-a in the mixture × ln(viscosity A2-a) + proportion A2-b in the mixture × ln(viscosity A2-b). A viscosity >5 Pa*s is disadvantageous in processing.

TABLE 4

| Examples (*are comparative examples) | | 1* | 2* | 3 | 4 | 5 | 6* | 7* |
|---|---|---|---|---|---|---|---|---|
| Mixing time (s) | s | 8 | 8 | 8 | 8 | 8 | 8 | 8 |
| Cream time (s) | s | 10 | 15 | 10 | 10 | 10 | 10 | 10 |
| Rise time (s) | s | 55 | 45 | 35 | 35 | 35 | 35 | 35 |
| Apparent density, core | g/dm³ | 26.2 | 25.9 | 31.8 | 30.6 | 30.4 | 32.4 | 30.5 |
| Open-cell content | | 10% | 53% | 18% | 13% | 8% | 59% | 34% |
| Compressive strength in rise direction | kPa | 221 | 156 | 201 | 234 | 243 | 192 | 225 |
| Cell structure | | No defects | Severe | Few slight | Foam looks | Defects in | Severe | Severe |
| | | | defects in top | defects | best | top surface of | defects in top | defects in top |
| | | | surface and | | | the foam | surface and | surface and |
| | | | core of the | | | | core of the | slight defects |
| | | | foam | | | | foam | in core of the |
| | | | | | | | | foam |
| Small burner test | | | | | | | | |
| SBT flame height | cm | 13 | 10 | 8 | 10 | 10 | 10 | 10 |
| Cone calorimeter | | | | | | | | |
| MARHE | kW/m² | 83 | 81 | 85 | 85 | 82 | 80 | 89 |
| CO yield | mol/kg | 8.6 | 6.6 | 7.3 | 7.0 | 7.1 | 7.2 | 7.1 |
| Residue after test | % by | 35 | 32 | 30 | 31 | 33 | 35 | 36 |
| | weight | | | | | | | |
| SEA | | 95 | 319 | 221 | 187 | 211 | 214 | 186 |

1. A polyol formulation A containing comprising:
A1 35-89% by weight, based on the total mass of the polyol formulation A, of a polyester polyol component having an OH number of 190-310 mg KOH/g, consisting of
A1-1 at least one polyester polyol having an OH number ≤250 mg KOH/g, a functionality of 1.5-2.5 and a content of free glycols of Mₙ<150 g/mol of <6% by weight based on the total mass of A1-1, and
A1-2 optionally further polyester polyols not falling under the definition of A1-1;
A2 10-40% by weight, based on the polyol formulation A, of one or more polyethylene glycols having a number-average molar weight Mₙ of <700 g/mol and an average functionality of <2.5;
A3 optionally further isocyanate-reactive components;
A4 0.2-5% by weight, based on the polyol formulation A, of one or more compounds selected from the group consisting of
A4-1 a polyethylene glycol 2,4,6-trialkylphenyl ether of structure I wherein R5, R6, R7=H, C1- to C8-alkyl,
A4-2 polyethylene glycol 2,4,6-triaralkylphenyl ethers [[(]] of structure I wherein R5, R6 and/or R7=aryl, and
A4-3 polyethylene glycol alkyl phenyl ethers of structure II, 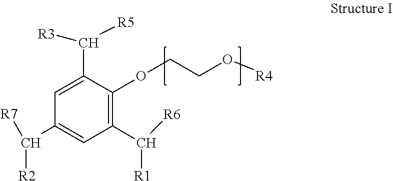
R1, R2, R3, R4=H, C1-C4-alkyl,
R5, R6, R7=H, C1- to C8-alkyl, aryl, and
n=7-20, 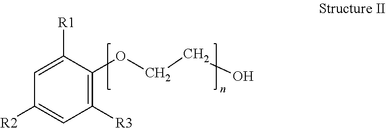
R1, R3=H, C(CH₃)₂CR4R5R6,
R2=C(CH₃)₂CR4R5R6,
R4, R5=H or CH₃,
R6=C2- to C5-alkyl, aryl, and
n=3-8,
wherein the compounds A4 have a number-average molecular weight Mn of less than 1.5 kg/mol and a content of 25-70% ethylene oxide,
A5 optionally further auxiliary and additive substances; and
A6 0-2% by weight, based on the total mass of the polyol formulation A, of water,
wherein values of Mₙ are determined according to DIN 55672-1 (August 2007).

2. The polyol formulation A as claimed in claim 1, wherein the polyol component A1-1 has a dynamic viscosity (25° C., determined according to DIN EN ISO 3219:1994-10 at 25° C. of >5 Pa*s.

3. The polyol formulation A as claimed in claim 1, wherein the mass ratio of A1-1 to A1-2 is at least 6:1.

4. The polyol formulation A as claimed in claim 1, wherein the polyol component A2 has an Mₙ of 200-600 g/mol.

5. The polyol formulation A as claimed in any claim 1, wherein the polyol component A2 has an average functionality of ≤2.12.

6. The polyol formulation A as claimed in claim 1, wherein the polyol component A2 has an average functionality of ≤2.12 and an Mₙ of 200-600 g/mol.

7. The polyol formulation A as claimed in claim 1, wherein the polyol component A5 comprises a flame retardant.

8. The polyol formulation A as claimed in claim 1, wherein the mixture of the polyols A1 and A2 has a dynamic viscosity according to DIN EN ISO 3219: 1994-10 at 25° C. of ≤4 Pa*s.

9. A method for producing rigid PUR/PIR foams with a polyol formulation as claimed in claim 1.

10. A reaction mixture for producing rigid PUR/PIR foams comprising
a polyol formulation A as claimed in claim 1,
a polyisocyanate component B,
a blowing agent C,
optionally a catalytically active component D, having an isocyanate index of 150 to 600.

11. The reaction mixture as claimed in claim 10, wherein the polyisocyanate component B is selected from at least one compound from the group consisting of MDI, polymeric MDI and TDI.

12. A process for producing rigid PUR/PIR foam comprising reacting the reaction mixture as claimed in claim 10.

13. A rigid PUR/PIR foam obtained by the process as claimed in claim 12.

14. A method for producing an insulation material and/or composite elements with rigid PUR/PIR foams as claimed in claim 13.

15. The polyol formulation A as claimed in claim 1, wherein in Structure I, n=11-15.

16. The polyol formulation A as claimed in claim 1, wherein the compounds A4 have a number-average molecular weight Mn of less than 1.5 kg/mol and a content of 40-60% ethylene oxide.

17. The polyol formulation as claimed in claim 3, wherein the mass ratio of A1-1 to A1-2 is at least 8:1.

18. The polyol formulation A as claimed in claim 8, wherein the mixture of the polyols A1 and A2 has a dynamic viscosity determined according to DIN EN ISO 3219: 1994-10 at 25° C. of 2-4 Pa*s.

19. The reaction mixture as claimed in claim 11, wherein the polyisocyanate component B is polymeric MDI.
